(19) United States
(12) Patent Application Publication
(10) Pub. No.: US 2005/0248424 A1
(43) Pub. Date: Nov. 10, 2005

(54) Composite beam microelectromechanical system switch

(76) Inventors: Tsung-Kuan Chou, San Jose, CA (US); John Heck, Berkeley, CA (US)

Correspondence Address: TROP PRUNER & HU, PC, 8554 KATY FREEWAY, SUITE 100, HOUSTON, TX, 77024, US

(21) Appl. No.: 10/841,385

(22) Filed: May 7, 2004

(51) Int. Cl. H01H 51/22

(52) U.S. Cl. 335/78

(57) ABSTRACT

A cantilevered beam radio frequency microelectro-mechanical switch may be formed of low stress gradient polysilicon with a metallic contact. The region between the beam and the substrate may be free of dielectric in some embodiments. Oxide layers may be protected by a nitride protection layer in some cases.

### BACKGROUND

This invention relates generally to microelectro-mechanical systems technology.

In microelectromechanical systems, mechanical and electrical components can be fabricated using integrated circuit techniques at nanoscale sizes. A variety of devices can be made including switches. Such switches may be on the order of micrometers in size.

The movable switch element of a conventional radio frequency microelectromechanical switch is generally formed of plated gold or nickel. However, electroplated thick metals suffer from high stress gradients. The stress gradient in plated gold or nickel may not be a significant issue for a high voltage switch (˜40V) with beam size of ˜100 um (˜0.3 um bending over 100 um beam). However, this stress gradient bending is much worse with long switch beams for ultra-low actuation voltage (e.g., on the order of 3V), which requires the switch length of 350 um (e.g., 3 um bending over 350 um long beam). The curving of the long switch beam results in much larger air gap between actuation electrode and switch beam, which makes the 3V electrostatic actuation unachievable. Meanwhile, such stress gradients of plated gold and nickel also have significant non-uniform upward bending of the movable switch element, which results in inconsistent device characteristics.

Thus, there is a need for better ways to make microelectromechanical system switches for radio frequency applications.

### BRIEF DESCRIPTION OF THE DRAWINGS

FIG. 1 is an enlarged, cross-sectional view of one embodiment of the present invention;

FIG. 2 is an enlarged, cross-sectional view at an early stage of manufacture in accordance with one embodiment of the present invention;

FIG. 3 is an enlarged, cross-sectional view at a subsequent stage of manufacture in accordance with one embodiment of the present invention;

FIG. 4 is an enlarged, cross-sectional view at a subsequent stage of manufacture in accordance with one embodiment of the present invention;

FIG. 5 is an enlarged, cross-sectional view at a subsequent stage of manufacture in accordance with one embodiment of the present invention;

FIG. 6 is an enlarged, cross-sectional view of one embodiment of the present invention at a subsequent stage of manufacture;

FIG. 7 is an enlarged, cross-sectional view of one embodiment of the present invention at a subsequent stage of manufacture;

FIG. 8 is an enlarged, cross-sectional view of one embodiment at a subsequent stage of manufacture;

FIG. 9 is an enlarged, cross-sectional view at a subsequent stage of manufacture in accordance with one embodiment of the present invention;

FIG. 10 is an enlarged, cross-sectional view at a subsequent stage of manufacture in accordance with one embodiment of the present invention;

FIG. 11 is an enlarged, cross-sectional view at a subsequent stage of manufacture in accordance with one embodiment of the present invention;

FIG. 12 is an enlarged, cross-sectional view of one embodiment of the present invention at a subsequent stage of manufacture;

FIG. 13 is an enlarged, cross-sectional view of one embodiment at a subsequent stage of manufacture;

FIG. 14 is an enlarged, cross-sectional view of one embodiment at a subsequent stage of manufacture;

FIG. 15 is an enlarged, cross-sectional view of one embodiment of the present invention at a subsequent stage of manufacture;

FIG. 16 is an enlarged, cross-sectional view of one embodiment at a subsequent stage of manufacture;

FIG. 17 is an enlarged, cross-sectional view of one embodiment at a subsequent stage of manufacture;

FIG. 18 is an enlarged, cross-sectional view of the completed switch in accordance with one embodiment of the present invention in the open or unactuated position; and

FIG. 19 is an enlarged, top plan view of the embodiment shown in FIG. 18.

### DETAILED DESCRIPTION

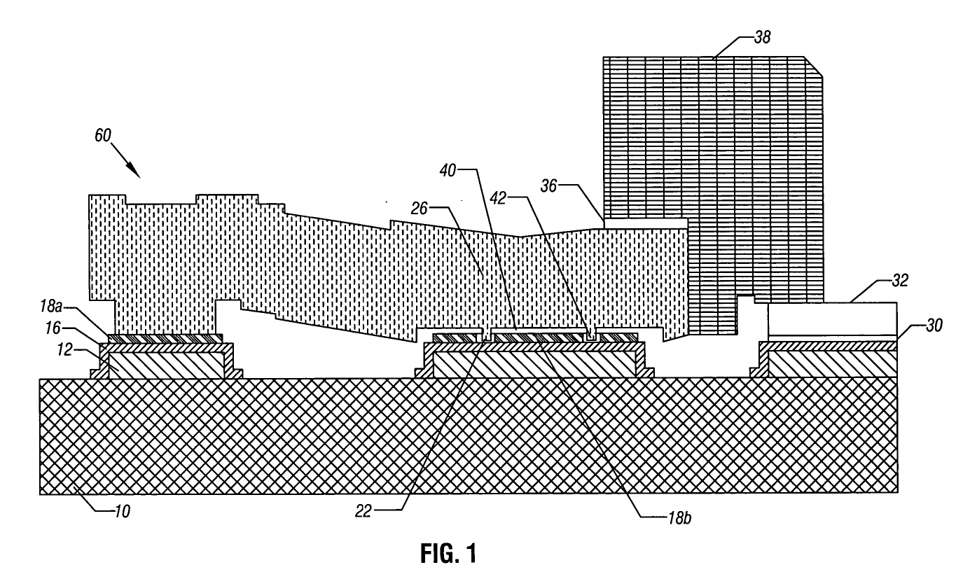

Referring to FIG. 1, a microelectromechanical system (MEMS) switch 60 may be formed on a semiconductor substrate 10. In one embodiment, the substrate 10 may be a high resistivity silicon material. A cantilevered beam 26 is mounted over the substrate 10. The cantilevered beam 26 is formed of low stress gradient polysilicon in one embodiment of the present invention. Low stress gradient polysilicon does not curve substantially after it is released (e.g., less than 25 nm bending over 350 um long beam). Therefore, the air gap between the beam and actuation electrode can be retained vary small after the polysilicon beam is released. The beam 26 is shown in the switch closed position in FIG. 1 with the beam 26 contacting fixed bottom electrode portions 32. The switch 60 closes an electrical connection between the spaced bottom electrode portions 32.

Over the substrate 12 may be an oxide island 12 covered by a nitride protection layer 16 in one embodiment of the present invention. The nitride protection layer 16 may then be covered by the bottom electrode 18 in some embodiments. The bottom actuation electrode 18 may be formed of polysilicon in one embodiment of the present invention. The bottom surface of the beam 26 may include a pair of stopper bumps 42 that engage openings 44 in the bottom electrode 18b.

Mounted on the end portion 36 of the top electrode 26 is a metallic contact 38 (e.g., Au). In the closed position, the plating 38 engages bottom contact metal portions 32. The metal portions 32 may each be positioned over an adhesion layer 30 (e.g., Mo or Cr) in one embodiment of the present invention.

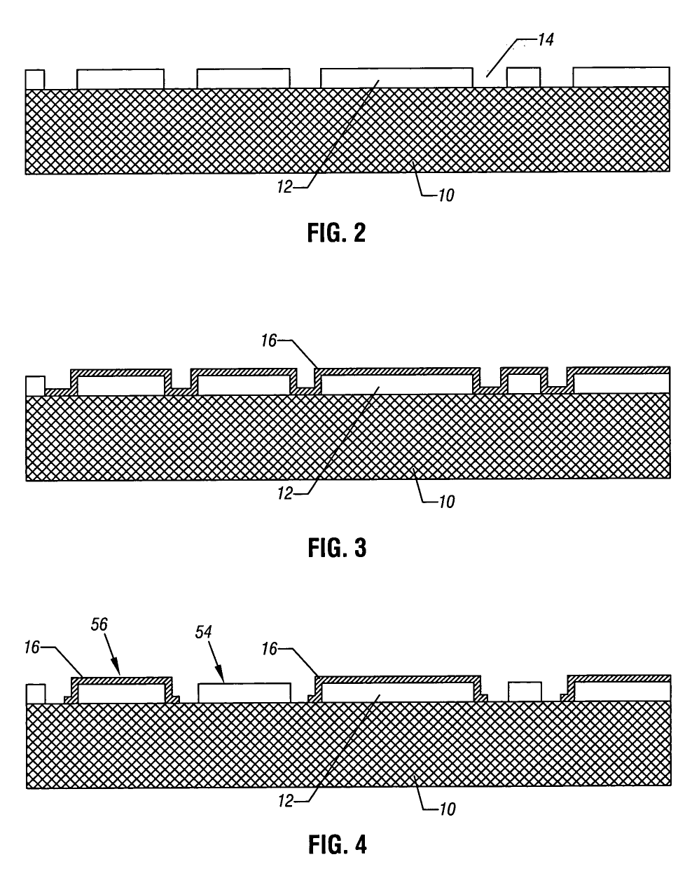

One exemplary process for making the switch 60 is shown in FIGS. 2 through 17. In FIG. 2, a high resistivity silicon wafer 10 may be covered with a layer of isolation oxide. The isolation oxide may be patterned to form the openings 14 and to create a series of oxide islands 12 in one embodiment of the present invention. The islands 12 may reduce parasitic capacitance to the silicon substrate. The islands 12 may be omitted, for example, when parasitic capacitance is not an issue.

As shown in FIG. 3, the islands 12 may be covered with a protection nitride layer 16. The layer 16 protects the underlying oxide islands 12 during release etch in which the beam 26 is freed by immersing the wafer 10 in a hydrofluoric acid solution.

Referring to FIG. 4, the nitride protection layer 16 is removed at some locations 54 and maintained at other locations 56. The nitride protection layer 16 in the remaining areas is etched away so that there will no dielectric in the critical region of the silicon surface (under the beam 26, and space between contact electrodes 32) after final sacrificial oxide etch. The removal of dielectric may improve the radio frequency performance of the transmission lines on the high resistivity silicon wafer 10 in some embodiments.

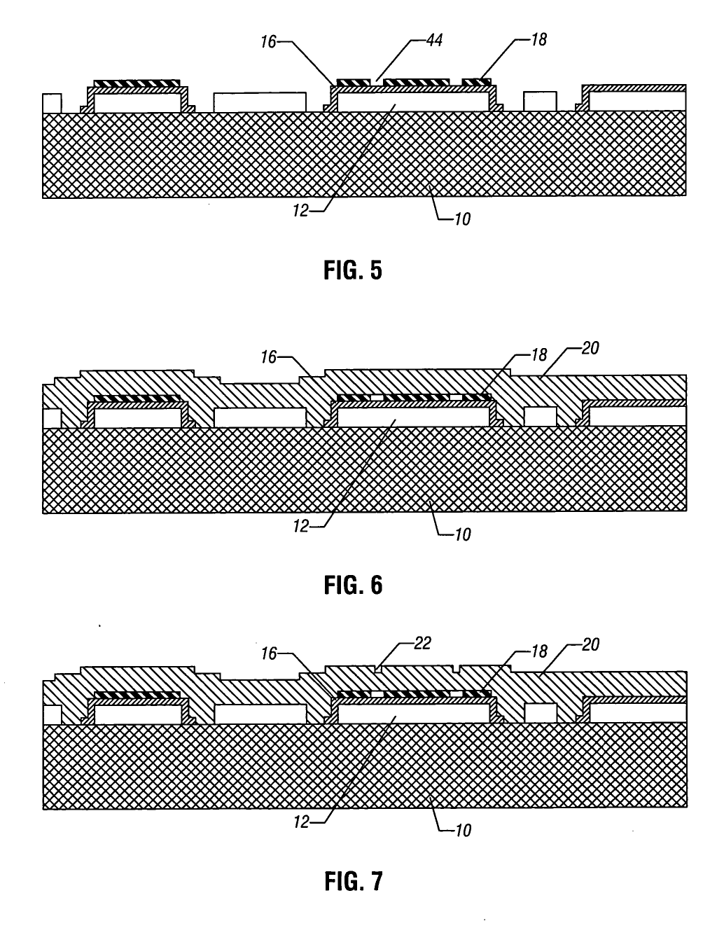

Turning next to FIG. 5, a bottom actuation electrode 18 may be deposited and patterned. The bottom electrode 18 is only formed over the nitride protection layer 16. In some cases, contact holes 48 are provided at spaced locations through the layer 18. In one embodiment, the layer 18 may be a polysilicon bottom electrode having a thickness of approximately 1000 Angstroms.

Moving to FIG. 6, a first release layer 20 may be formed of deposited oxide. In one embodiment, the layer 20 may have a thickness on the order of 0.5 microns. While an oxide layer 20 is illustrated, other sacrificial materials may be utilized to temporarily support the beam 26 during its fabrication.

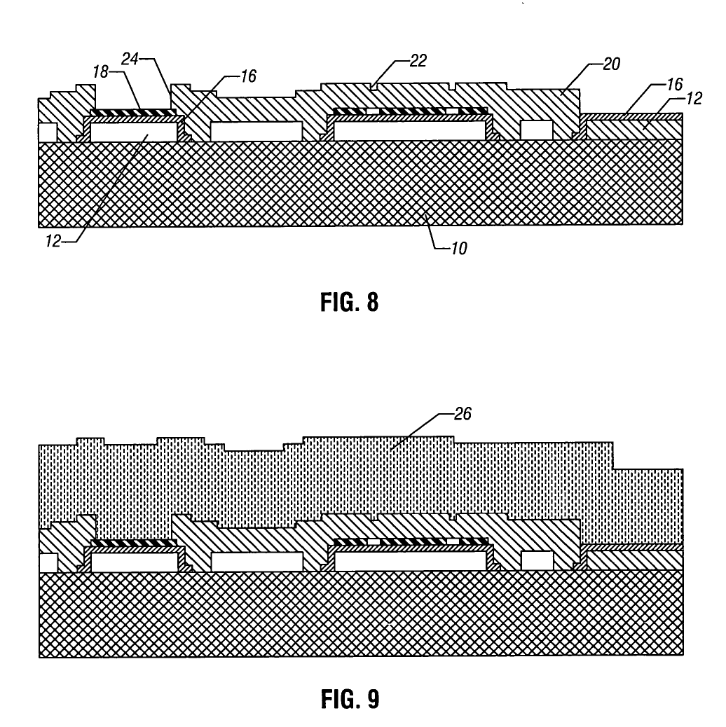

Referring to FIG. 7, the mold regions 22 for forming stopper bumps 42 (FIG. 1) are etched by a short, timed, oxide etch. Another oxide etch, illustrated in FIG. 8, forms the opening 24 to receive material that will anchor the cantilevered beam 26. Then, as shown in FIG. 9, low stress gradient polysilicon may be deposited to form the beam 26. Some dopant implantation may be performed over the polysilicon for desired conductivity and stress tuning.

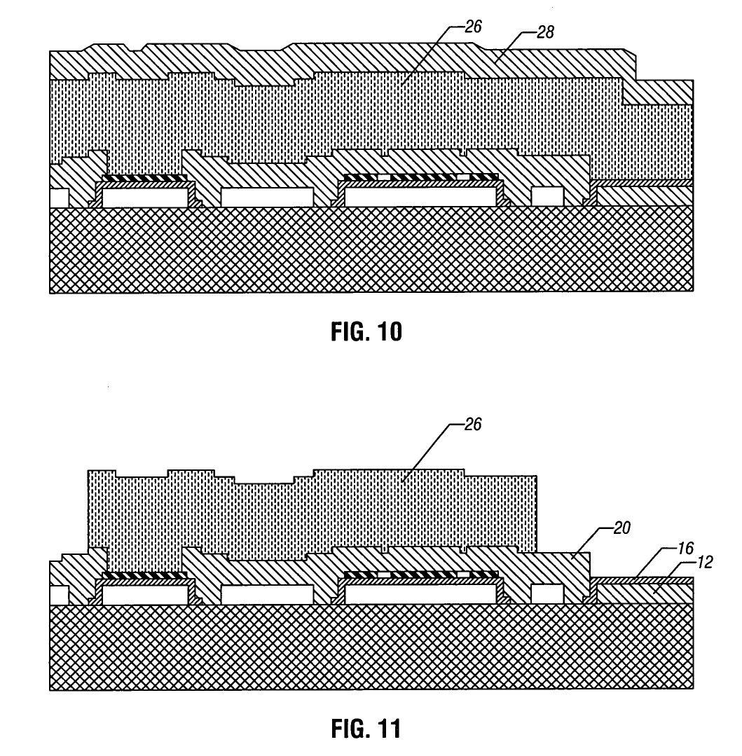

A cap oxide 28 may be formed over the low stress polysilicon as shown in FIG. 10. The multi-layer sacrificial oxide, low stress gradient polysilicon, and cap oxide 28 may be annealed in some embodiments to control the stress and stress gradient of the polysilicon beam 26. The beam 26 may have a thickness of 2 microns in one embodiment of the present invention. The cap oxide 28 may then be removed as shown in FIG. 11.

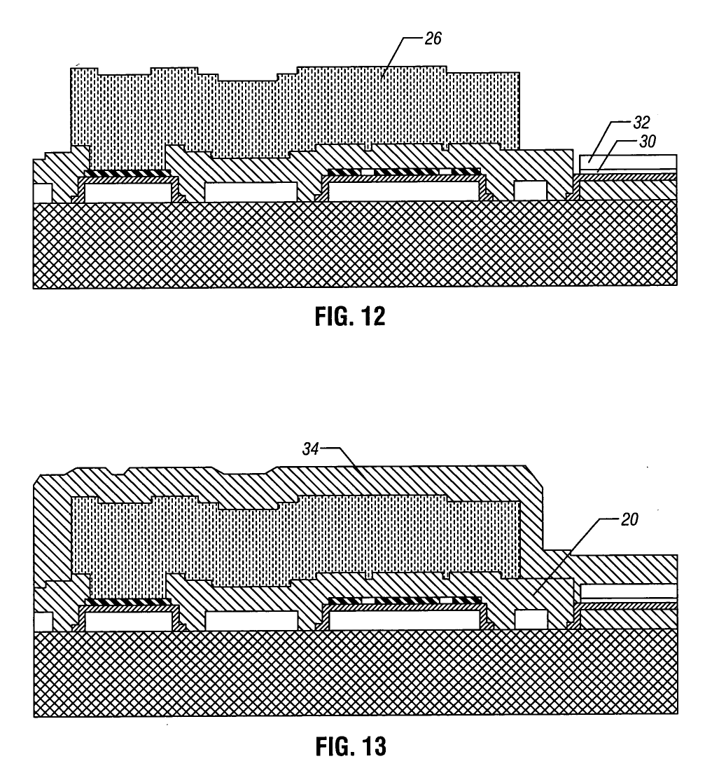

A bottom electrode, made up of the layers 32 and 30, may be deposited and patterned as shown in FIG. 12. The upper layer 32 may be Au and the lower layer 30 may be Cr or Mo in one embodiment. Both layers 30, 32 are deposited after the main structural layers. The contact metal layer 32 and adhesion layer 30 advantageously withstand the release process which uses hydrofluoric acid in one embodiment of the present invention.

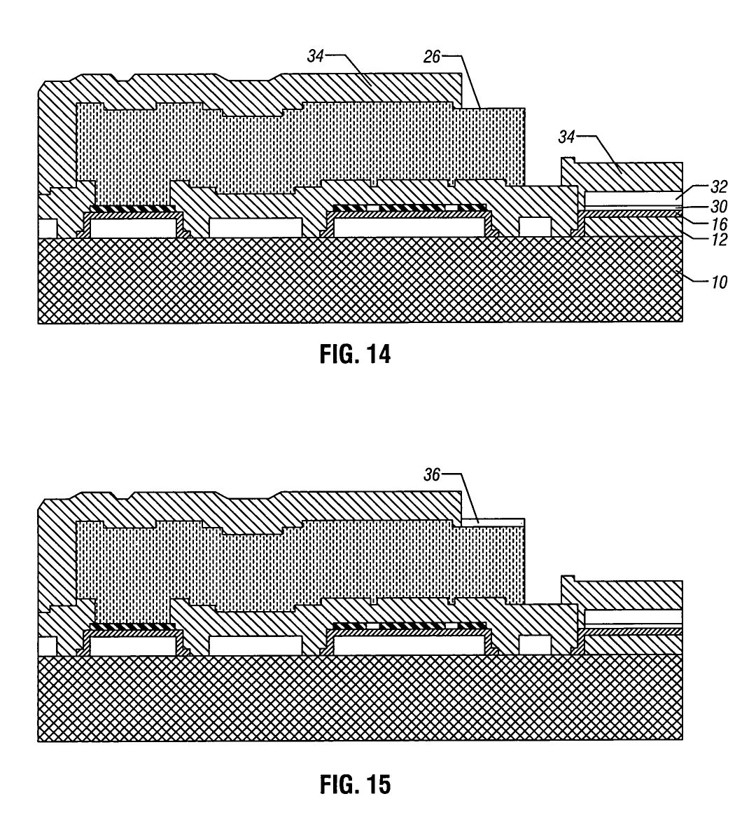

Next, a second release layer 34 may be formed as shown in FIG. 13 by a sacrificial copper deposition. The thickness of the layer 34 may be approximately 0.35 microns, which is less than the thickness of the oxide 20. Then, as shown FIG. 14, the layer 34 may be etched. An opening may be etched in the layer 34 down to the beam 26 and the first release layer 20 may be deposited and patterned as shown in FIG. 15. The adhesion metal 36 (e.g., Mo) is adapted to withstand the release process.

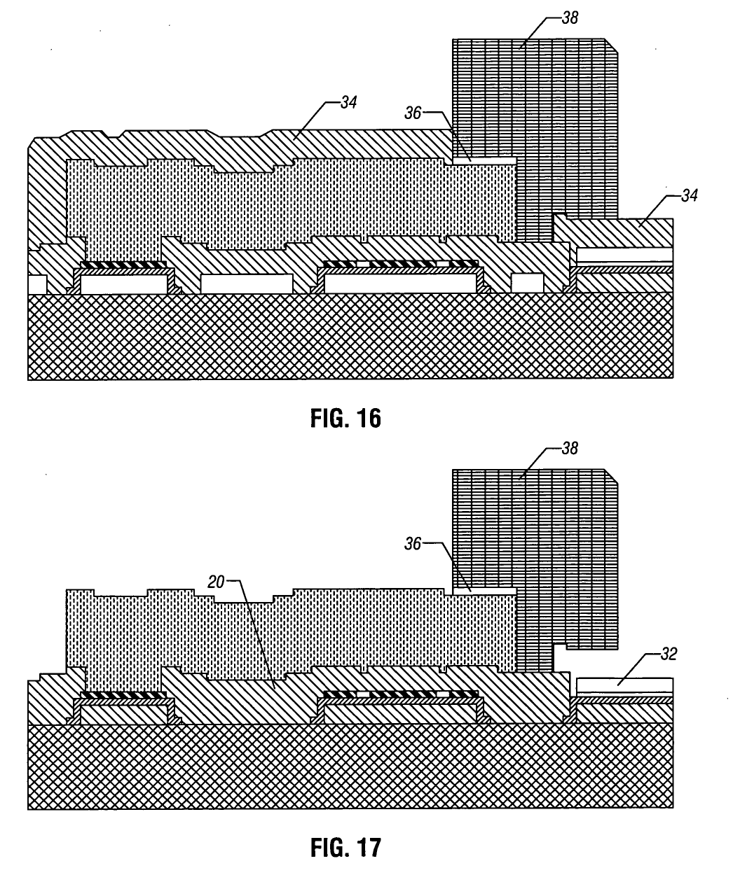

As shown in FIG. 16, a metallic contact 38 is formed in one embodiment of thick (e.g., 4-6 um) but short (e.g., less than 30 um in lateral dimension) plated Au (not to scale in the drawing). The plated contact 38 is used to provide good electrical conductance for a radio frequency (RF) signal once the switch is closed. Since the contact 38 serves only as the electrical conducting patch for RF signal, it may have a small lateral dimention compared to the main switch beam 26. Therefore, a very short contact 38 may not have significant bending from its stress gradient (e.g., less then 25 nm of 30 um). The contact 38 may be T-shaped with one arm on the metal 36 over the beam 26, the base on the second release layer 34 and the other arm on the release layer 34. Then, as shown in FIG. 17, the layer 34 is selectively etched away.

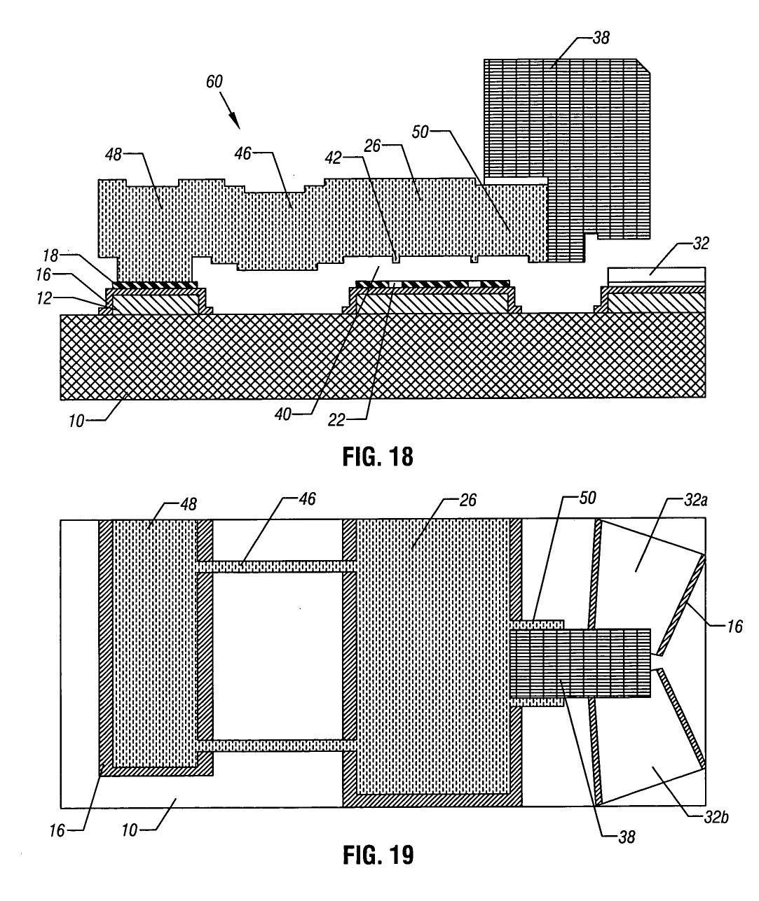

Finally, as shown in FIG. 18, the sacrificial layer 20 (FIG. 17)(e.g., oxide) is etched away in hydrofluoric acid to release the movable polysilicon beam 26. No dielectric layer then may exist in the open area 40 between structures in one embodiment of the present invention. As a result, better radio frequency performance may be achieved in such an embodiment.

Referring to FIG. 19, the beam 26 includes an anchor portion 48, coupled by ribs 46, to a contact portion 26. The contact 38 may be formed relatively centrally over a portion 50 of the beam 26. A pair of trapezoidally shaped bottom electrode portions 32a and 32b are aligned under the contact 38. In one embodiment, the portion 32a provides the radio frequency input signal and the portion 32b provides the output signal when the switch 60 is closed.

The switch 60 is closed by applying a voltage between the low stress gradient polysilicon beam 26 and the polysilicon bottom electrode 18. Due to the usage of low stress gradient polysilicon in this process, the air gap between beam 26 and electrode 18 can remain very small (e.g., less than 0.6 um). Thus, ultra-low actuation voltage switch can be achieved in some embodiments. When the polysilicon beam 26 is actuated down, the contact 38 makes contact to the bottom electrode portions 32 since the remaining gap between the electrode 18 and beam 26 can be precisely controlled by the sacrificial film thickness deposition.

When further voltage is applied, the polysilicon beam 26 is allowed to collapse to have a higher contact force. However, the contact 38 and beam 26 may still be separated from the bottom electrode 18, as shown in FIG. 1. This separation is due to the provision of the polysilicon stoppers 42 which contact the nitride protection layer 16 without contacting the bottom electrode 18 because the mold regions 22 are larger than the stoppers 42.

In some embodiments of the present invention, gold is used as the contact component and conductor for radio frequency signal transmission with a low loss. Those gold structures may be deposited after fabrication of the polysilicon structure which can be carried out entirely in a clean room. Isolation paths consisting of silicon dioxide may be encapsulated by a silicon nitride protection layer 16. The silicon nitride protection layer 16 may protect the underlying oxide 12 during the release etch in which the beam 26 is freed by immersing the wafer in hydrofluoric acid.

In some embodiments, a relatively small air gap 40 may be achieved for ultra-low voltage switch fabrication without suffering from severe structure bending. The use of a low stress gradient polysilicon film is more consistent and easier to control in fabrication. The material may also have better mechanical reliability in harsh environments.

In some embodiments, a precise film thickness deposition may produce effective contact height, providing better contact height control and consistency compared to direct etching. The localized protective nitride protection layer may allow oxide release etching while still achieving good radio frequency transmission without leaving dielectric at critical areas. Dielectric between the beam 26 and the bottom electrode 18 may become charged and such charging may adversely affect the operation of the switch 60 in some cases. In some embodiments, a polysilicon stopper may be integrated into the process to allow switch 60 collapse for higher contact force without using a dielectric.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
forming a microelectromechanical system switch with a cantilevered beam having a low stress gradient polysilicon portion attached to a metallic contact.

2. The method of claim 1 including forming the switch having a bottom electrode to apply an attractive force to said beam to close said switch.

3. The method of claim 2 including maintaining the region between said bottom electrode and said beam free of dielectric.

4. The method of claim 2 including mounting said beam on a substrate, providing a pair of spaced substrate contacts on said substrate, and arranging said metallic contact over said substrate contacts so that when said switch is closed, an electrical connection is made between said substrate contacts.

5. The method of claim 4 including forming a gap between said metallic contact on said cantilevered beam and said substrate contacts greater than the gap between said polysilicon portion of said cantilevered beam and said bottom electrode.

6. The method of claim 4 including forming a release layer over said substrate and forming said polysilicon portion over said release layer.

7. The method of claim 6 including securing said metallic contact to said polysilicon portion before releasing said release layer.

8. The method of claim 6 including releasing said release layer after securing said metallic contact to said polysilicon portion.

9. The method of claim 1 including forming said cantilevered beam on a substrate, forming oxide islands on said substrate and covering said oxide islands with a nitride protection layer, forming a release layer over said nitride protection layer, and using an etching solution to remove said release layer.

10. An electrostatically actuated microelectro-mechanical system switch comprising:
a substrate;
a cantilevered beam mounted on said substrate, said beam formed of a combination of low stress gradient polysilicon and a metallic contact; and
a bottom electrode formed over said substrate to attract said beam toward said substrate.

11. The switch of claim 10 including a pair of contacts formed on said substrate, said contacts being spaced apart such that when said cantilevered beam is pulled downwardly to the substrate, a circuit is completed between said substrate contacts.

12. The switch of claim 11 wherein the cantilevered beam metallic contact has an offset portion, said offset portion to contact the pair of contacts on said substrate.

13. The switch of claim 11 including an oxide island and a nitride protection layer over said island, said substrate contacts mounted over said oxide island on said nitride protection layer.

14. The switch of claim 11 wherein when said metallic contact on said beam contacts said pair of contacts on said substrate, said beam is spaced over said bottom electrode.

15. The switch of claim 11 wherein said metallic contact and said substrate contacts are formed with contact surfaces formed of the same material.

16. The switch of claim 10 wherein the region between said bottom electrode and said cantilevered beam is free of dielectric.

17. The switch of claim 10 including oxide formed over said substrate, said oxide being covered by a nitride protection layer.

18. The switch of claim 10 wherein at least one aperture is formed in said bottom electrode, said cantilevered beam having a stopper to extend through said aperture in said bottom electrode.

19. The switch of claim 10 including an oxide island and a nitride protection layer over said island, said cantilevered beam mounted over said oxide island on said nitride protection layer.

20. A method comprising:
forming a first release layer over a substrate;
depositing low stress polysilicon over said release layer;
removing a portion of said low stress gradient polysilicon;
covering said low stress polysilicon with a second release layer;
forming an opening through said second release layer to said low stress gradient polysilicon and to said first release layer; and
depositing a metal contact in said aperture.

21. The method of claim 20 including forming said first release layer of an insulator and forming said second release layer of metal.

22. The method of claim 20 including forming a bottom electrode before forming said first release layer.

23. The method of claim 22 including forming at least one opening in said bottom electrode and forming at least one protrusion on said low stress polysilicon to extend into said bottom opening without touching said bottom electrode.

24. The method of claim 20 including forming a pair of contacts on said substrate spaced from one another.

25. The method of claim 24 including aligning said metal contact over said pair of contacts formed on said substrate.

26. The method of claim 20 including forming a micro-electromechanical switch using said polysilicon and said metal contact as a cantilevered beam.

27. The method of claim 20 including forming a bottom electrode underneath said first release layer and forming a microelectromechanical switch with said polysilicon and said metal contact acting as a cantilevered beam, and avoiding any dielectric in the region between said bottom electrode and said cantilevered beam.

28. The method of claim 20 including forming said second release layer thinner than said first release layer.

29. The method of claim 20 including forming an oxide island on said substrate, and covering said oxide island with a nitride protection layer before forming said first release layer.

30. The method of claim 20 including forming said metal contact in a T-shape with a base of said contact extending to said first release layer, one arm of said contact being mounted atop said polysilicon and the other arm of said contact being mounted atop said second release layer.

31. The method of claim 20 including releasing said second release layer before releasing said first release layer.
